(19) United States
(12) Patent Application Publication
(10) Pub. No.: US 2013/0093380 A1
(43) Pub. Date: Apr. 18, 2013

(54) SOLAR CHARGE CONTROLLER WITH TIME-VARIABLE CHARGING STATES AND TIME-EQUAL SHUNTING STATES

(71) Applicant: Scott Kennedy Gallert, Vancouver, WA (US)

(72) Inventor: Scott Kennedy Gallert, Vancouver, WA (US)

(21) Appl. No.: 13/274,619

(22) Filed: Oct. 17, 2011

(51) Int. Cl. H01M 10/46; H02J 7/00

(52) U.S. Cl. 320/102; 320/107

(57) ABSTRACT

Solar powered battery charging circuitry is provided. A charge controller receives electrical energy from a photovoltaic panel. Timer circuitry provides a control signal. A duty cycle of the control signal is determined by way of comparing a time-varying capacitor voltage to a lesser threshold voltage and a greater threshold voltage. The control signal is characterized by time-variable charging states and time-equal shunting states. Transfer of electrical energy from the photovoltaic panel to the storage battery is regulated by a shunting element using the control signal.

### BACKGROUND

A photovoltaic panel generates electrical energy by direct conversion of incident sunlight. The resulting electrical energy can be accumulated in a storage battery. However, it is necessary to regulate the electrical charge provided to the storage battery so as to protect against excessive voltage and various problems related thereto. The present teachings are directed to the foregoing and other concerns.

### BRIEF DESCRIPTION OF THE DRAWINGS

The present embodiments will now be described, by way of example, with reference to the accompanying drawings, in which:

FIG. 1 depicts a block diagram of a solar energy system in accordance with the present teachings;

FIG. 2 depicts a schematic block diagram of a charge controller according to the present teachings;

FIG. 3 depicts a schematic diagram of an electronic circuit according to a preferred embodiment of the present teachings;

FIG. 4 depicts a table of illustrative constituents in accordance with the electronic circuit of FIG. 3;

FIG. 5 depicts a table of illustrative performance values in a accordance with a charge controller of the present teachings;

FIG. 6 depicts a signal timing diagram according to one example of the present teachings.

### DETAILED DESCRIPTION

### Introduction

Systems and circuitry are provided for charging a storage battery or batteries by way of solar power. A charge controller receives electrical energy from a photovoltaic panel. The charge controller is also coupled to a storage battery. Timer circuitry of the charge controller senses a time-varying capacitor voltage that is compared to lesser and greater threshold voltages, respectively. A control signal is generated by the timer circuitry in accordance with the comparisons.

The control signal is characterized by time-variable charging states and time-equal shunting states. Transfer of electrical energy from the photovoltaic panel to the storage battery is regulated by a shunting element in accordance with the control signal. The storage battery is protected against overcharging and related problems by way of the charge controller.

In one example, an electronic circuit includes a zener diode and a first resistor and a second resistor and a capacitor connected in series circuit arrangement, and defining at least a portion of a timing network. The timing network is electrically connected between an output node and a ground node. The timing network is configured to provide a time-varying signal. The electronic circuit also includes timer circuitry configured to provide a digital signal by way of comparing the time-varying signal with a lesser threshold voltage and a greater threshold voltage. The digital signal is characterized by about time-equal shunting states and time-variable charging states. The electronic circuit further includes a switching element configured to shunt an input node to the ground node in accordance with the digital signal.

In another example, a solar power system includes a photovoltaic panel configured to derive electrical energy by direct conversion of incident solar energy. The solar power system also includes a storage battery configured to store electrical energy, and a charge controller configured to regulate a transfer of electrical energy from the photovoltaic panel to the storage battery. The charge controller is configured to shunt electrical current back to the photovoltaic panel in accordance with a control signal. The control signal is characterized by about time-equal shunting states and time-variable charging states.

### Illustrative System

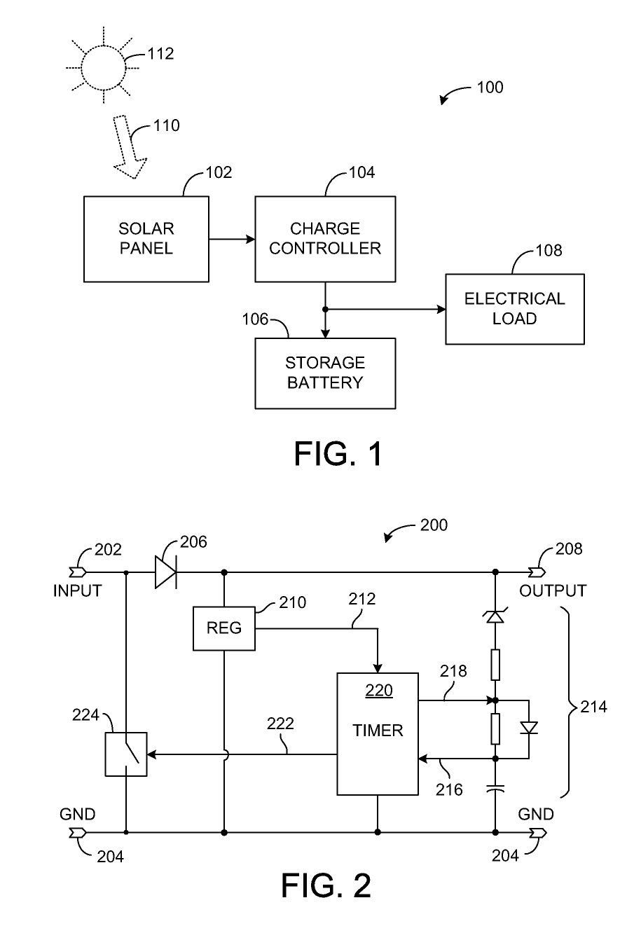

Reference is now made to FIG. 1, which depicts a block diagram of a system 100 according to the present teachings. The system 100 is illustrative and non-limiting with respect to the present teachings. Other systems, devices and their respective constituencies can also be used. The system 100 is also referred to as a solar energy system 100 for purposes herein.

The system 100 includes a solar panel 102. The solar panel 102 is also referred to as a photovoltaic (PV) panel 102. The solar panel 102 is configured to derive or generate electrical energy by direct conversion of incident photonic energy (e.g., sunlight). In one example, the solar panel 102 is characterized by a peak output power of about fifty watts at about seventeen volts. Other suitable solar panels 102 can also be used.

The system 100 also includes a charge controller 104 in accordance with the present teachings. The charge controller 104 is coupled to receive electrical energy from the solar panel 102 and to provide a regulated transfer of that electrical energy to a storage battery 106. In particular, the charge controller 104 is configured to shunt at least some electrical energy back to the solar panel 102 by way of a switching element. Further description of charge controllers according to the present teachings is provided below.

The system 100 also includes a storage battery 106 as introduced above. The storage battery 106 can be any suitable battery configured to store electrical charge and to release that electrical charge to an electrical load. In one example, the storage battery 106 is a lead-acid type characterized by a nominal voltage of about twelve volts and a storage capacity of about one-hundred amp-hours. Other suitable storage batteries can also be used.

The system 100 further includes an electrical load 108. The electrical load 108 is coupled to receive electrical energy from the storage battery 106. The electrical load 108 can be defined by any suitable device, system or apparatus compatible with the voltage and current capacity of the storage battery 106. Non-limiting examples of the electrical load 108 include a radio transceiver, a global-positioning system (GPS) receiver, a portable computer, a power inverter, a lighting system or other utility of a recreational vehicle, and so on. Other suitable electrical loads can also be used.

Normal typical operations of the system 100 are generally as follows: incident photonic energy 110 from the sun 112 strikes the solar panel 102. Electrical energy, characterized by a voltage and a current, is provided from the solar panel 102 to the charge controller 104. In turn, the charge controller 104 regulates a transfer of electrical energy to the storage battery 106.

The electrical load 108 draws electrical energy from the storage battery 106 and/or charge controller 104 according to its own respective normal operations. The storage battery 106 can provide electrical energy to the electrical load 108 on a continuous or as-needed basis, while the solar panel 102 and charge controller 104 function to replenish the consumed electrical energy during times of sufficient incident sunlight.

### Illustrative Charge Controller

Attention is now turned to FIG. 2, which depicts a schematic block diagram of a charge controller (controller) 200 in accordance with the present teachings. The controller 200 depicts general constituency and principles of operation according to the present teachings. Thus, the controller 200 is illustrative and non-limiting in nature. Other charge controllers having other respectively varying constituencies or functions can also be used. In one example, the charge controller 104 is essentially equivalent to the controller 200.

The controller 200 is defined by an input node 202 and a ground node 204. The input node 202 is configured to be coupled to a positive output node of a solar panel (e.g., 102), while the ground node 204 is configured to coupled to a negative output node of the solar panel. The controller also includes a diode 206. The diode 206 can be any suitable diode such as a silicon rectifier diode, a Schottky power diode, and so on. The diode 206 is connected in series circuit arrangement between the input node 202 and an output node 208 of the controller 200. Electrical current flows from the input node 202 to the output node 208 by way of the diode 206 during normal charging operations of the controller 200.

The controller 200 also includes a voltage regulator 210. The voltage regulator 210 is coupled to nodes 204 and 208, respectively, and is configured to provide a regulated output voltage at a node 212. In one example, the voltage regulator 210 is defined by a three-lead linear voltage regulator configured to provide a constant output of about nine volts direct-current (DC). Other suitable voltage regulators can also be used.

The controller 200 also includes a timing network 214 defined by a zener diode and a first resistor and a second resistor and a capacitor in series circuit arrangement, and having a switching diode in parallel circuit arrangement with the second resistor. The timing network 214 is connected between the output node 208 and the ground node 204.

The timing network 214 is configured to receive electrical energy from a storage battery (e.g., 106) coupled to the nodes 208 and 204. Generally and without limitation, the timing network 214 effectively subtracts a voltage from the battery voltage by way of the zener diode, providing a resultant difference voltage. In one example, the timing network 214 is configured to subtract about 11.7 volts DC from the voltage present at the node 208. The difference voltage is used to charge the capacitor by way of the first and second resistors and the switching diode. Other embodiments can also be used.

The controller 200 includes an integrated circuit (IC) 220, coupled to nodes 212 and 204. The IC 220 includes or is defined by a timer circuit. In one example, the IC 220 is defined by a model NE555P Timer, as available from Texas Instruments Inc., Dallas, Tex., USA. Other suitable or equivalent timer integrated circuits can also be used.

The IC 220 is coupled to sense a time-varying signal (capacitor voltage) present at a node 216, as provided by the timing network 214. Additionally, the IC 220 is coupled to provide a switched or controlled ground (or discharge) signal at a node 218 that is coupled to the timing network 214. The IC 220 is further configured to provide a control signal at a node 222 that is coupled (directly or indirectly) to a switch or shunting element 224. The switch 224 is coupled between the input node 202 and the ground node 204.

Normal illustrative operations of the controller 200 are as follows: A solar panel (e.g., 102) is coupled to the input node 202 and the ground node 204. A storage battery (e.g., 106) is coupled to the output node 208 and the ground node 204. Thus, the ground node 204 is common to the solar panel, the charge controller 200 and the storage battery. The voltage regulator 210 functions to provide a regulated (i.e., constant) voltage at the node 212 that is provided to the IC 220.

The capacitor of the timing network 214 charges by way of the storage battery, providing a time-varying signal at the node 216. The timer circuit of the IC 220 senses and compares the time-varying signal at node 216 with a lesser threshold voltage and a greater threshold voltage. In one non-limiting example, the lesser threshold voltage is about 0.85 volts and the greater threshold voltage is about 1.7 volts. Other respective lesser and greater threshold values can also be used. The lesser and greater threshold voltages are derived at least in part by circuitry internal (i.e., inherent) to the IC 220.

The IC 220 also provides a two-state (or digital) control signal at the node 222, characterized by time-variable charging states and (about) time-equal shunting states. The control signal at node 222 toggles between the charging and shunting states in accordance with the time-varying signal/thresholds comparison described above.

During each charging state, the capacitor voltage at the node 216 increases toward the greater threshold voltage. The timer circuit of the IC 220 provides a continuous “high” state control signal at the node 222 during the charging state. The shunting element 224 is “open” (i.e., electrically non-conductive) during the charging state. Electrical current flows from the solar panel to the storage battery by way of the diode 206 during the charging state. Once the time-varying signal at node 216 reaches the greater threshold voltage, the end of the present charging state is ended and a shunting state begins.

During each shunting state, the timer circuit of the IC 220 provides a continuous “low” or about ground-level discharge signal at the node 218. The timer circuit of the IC 220 also provides a continuous “low” state control signal at the node 222. The shunting element 224 is “closed” (i.e., electrically conductive) during the shunting state. As a result, electrical current is shunted back to the solar panel and essentially no current flows to the storage battery during the shunting state.

The capacitor of the timing network 214 discharges toward the lesser threshold voltage by virtue of the second resistor and the discharge signal at node 218 during the shunting state. Once the time-varying signal at the node 216 reaches the lesser threshold voltage, the present shunting state is ended and a next charging state begins. Thus, the control signal at the node 222 toggles between charging and shunting states in a digital manner.

The charging states of the control signal at node 222 are time-variable in accordance with the voltage of the storage battery coupled to the output node 208 and ground node 204. Generally, when the storage battery voltage is lesser than a throttling threshold level, the charging state is indefinite and electrical current can flow continuously from the solar panel to the storage battery.

The throttling threshold level is approximately equal to the zener voltage of the timing network 214 plus the greater threshold voltage. In one non-limiting example, the throttling threshold is about equal to: 11.7 volts+1.7 volts=13.4 volts. Other examples corresponding to other respective values can also be defined and used.

The charging states decrease in duration as the storage battery voltage increases above the throttling threshold. In particular, the duration of each charging state is determined by the time required for the capacitor to charge from the lesser threshold voltage to the greater threshold voltage by way of the rest of timing network 214. The storage battery is protected against overcharging by virtue of the time-variable charging states. Generally, the resistance (Ohm) value of the first resistor of the timing network 214 can be increased in order to increase the durations of the time-variable charging states.

In contrast, the shunting states are about time-equal, being determined by the time required for the capacitor to discharge from the greater threshold voltage to the lesser threshold voltage by way of the second resistor. Since the storage battery voltage is not a factor, the shunting state durations are essentially equal. Generally, the resistance value of the second resistor of the timing network 214 can be increased in order to increase the duration of the time-equal shunting states.

### Illustrative Electronic Circuit

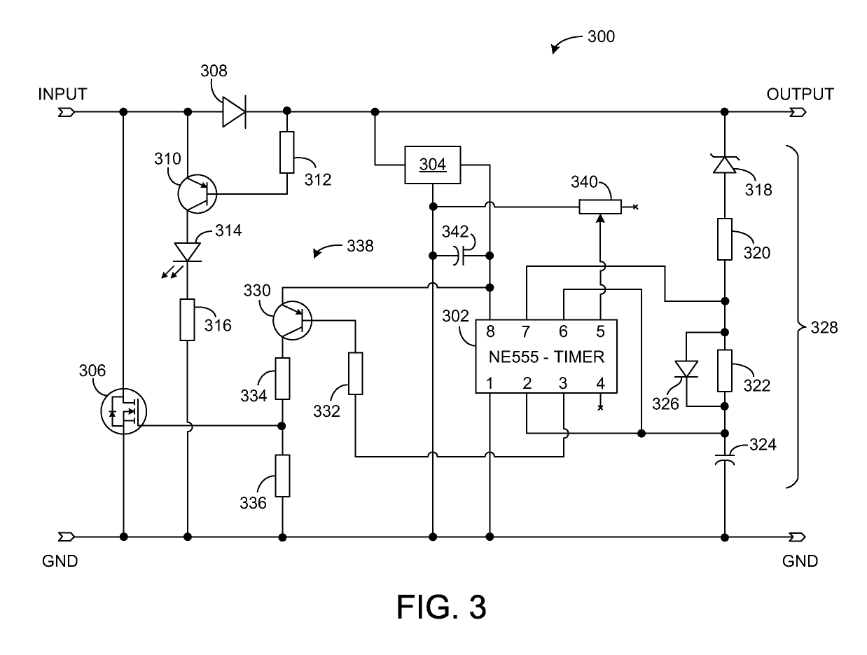

Attention is now turned to FIG. 3, which depicts a schematic diagram of an electronic circuit (circuit) 300. The circuit 300 is a charge controller according to a preferred embodiment of the present teachings. However, the circuit 300 is illustrative and non-limiting. The present teachings contemplate any number of other respectively varying circuits.

The circuit 300 is configured to be coupled to a solar panel (INPUT node and GND node) and to a storage battery (OUTPUT node and GND node) during typical normal operation. The circuit 300 operates generally as described above with respect to the charge controller 200, and as described in particular below.

The circuit 300 includes a timer integrated circuit (TIC) 302. As depicted, the TIC 302 is a model NE555 Timer, available from Texas Instruments Inc. Other suitable or analogous timer integrated circuits can also be used. The TIC 302 includes timer circuitry corresponding to pin numbers 2-7 (i.e., 2, 3, 4, 5, 6 and 7). The TIC 302 is also configured to be coupled to positive DC voltage at pin 8 and to ground potential at pin 1.

The timer circuitry of the TIC 302 is configured to provide a control signal (i.e., digital signal output) at pin 3. Pin 4 of TIC 302 is generally not used within the circuit 300 and is not germane to the present teachings. One having ordinary skill in the electronic and related arts can determine one or more suitable applications for pin 4, if desired.

The circuit 300 also includes a voltage regulator 304 such as, for non-limiting example, a model KA78L09A nine-volt output linear regulator, available from Fairchild Semiconductor, San Jose, Calif., USA. The voltage regulator 304 is configured to receive electrical energy from a storage battery via the OUTPUT node and to provide a regulated output voltage to pin 8 of the TIC 302.

The circuit also includes an N-channel power metal-oxide semiconductor field-effect transistor (MOSFET) 306. The MOSFET 306 is configured to act as a switch coupled between the INPUT node and the ground (GND) node, in accordance with a control signal provided by TIC 302. The MOSFET 306 therefore operates as a controllable shunting element.

The circuit further includes a diode 308. The diode 308 is connected between the INPUT node and the OUTPUT node. The diode 308 can be defined by, without limitation, a silicon rectifier diode, a Schottky diode, and so on. In one example, the diode 308 is a silicon rectifier diode having a forward current capacity of 6 amps DC. Other suitable diodes can also be used. The diode 308 is configured to provide one-way electrical current flow (conventional) from the INPUT node to the OUTPUT node during storage battery charging.

The circuit 300 also includes an indicator circuit (or circuitry) including a transistor 310 and a resistor 312 and a light-emitting diode (LED) 314 and a resistor 316. The transistor 310 is forward biased by way of the resistor 312 when current flows through the diode 308, in turn illuminating the LED 314. Thus, the LED 314 provides a visual indication of current flow from the INPUT node to the OUTPUT node during storage battery charging. Conversely, the LED 314 is not illuminated during shunting operations.

The circuit 300 includes a zener diode 318 and a resistor 320 and a resistor 322 and a capacitor 324 in series circuit arrangement, and a switching diode 326 in parallel circuit arrangement with the resistor 322, such that a timing network 328 is defined. The timing network 328 is coupled between the OUTPUT node and the GND node.

The circuit 300 includes a transistor 330 and a resistor 332 and a resistor 334 and a resistor 336, collectively defining inverter circuitry 338. The inverter circuitry 338 is configured to couple the MOSFET 306 to the control signal provided by the TIC 302. Specifically, inverter circuitry 338 operates to bias the MOSFET 306 into electrical conduction when the control signal at pin 3 of the TIC 302 is in a “low” state. The inverter circuitry 338 also operates to bias the MOSFET 306 into electrical non-conduction when the control signal at pin 3 is in a “high” state.

The circuit 300 also includes a potentiometer (pot) 340. One end of the pot 340 is coupled to the GND node, while the wiper is connected to pin 5 (i.e., control input) of the TIC 302. A greater threshold voltage, as used by the timer circuitry of the TIC 302, is adjustable by way of the pot 340. In one example, the pot 340 is adjusted to establish a greater threshold voltage of about 1.700 volts DC at pin 5. Other greater threshold voltages can also be used. A lesser threshold voltage equal to about one-half of the greater threshold voltage is derived by internal circuitry of the TIC 302.

The circuit 300 also includes a filter capacitor 342 coupled between the GND node and pin 8 of the TIC 302. The capacitor 342 operates to reduce ripple or noise at the output of the voltage regulator 304. Generally, the capacitor 342 operates to stabilize operation of the voltage regulator 304.

During charging operations of the circuit 300, the TIC 302 senses a time-varying signal (i.e., capacitor voltage) at pin 2 while the capacitor 324 charges from the lesser threshold voltage to the greater threshold voltage. Such charging is done by way of the remainder of the timing network 328, in accordance with a storage battery voltage coupled to the OUTPUT node. During this charging phase, the TIC 302 provides a “high” state control signal at pin 3 and the inverter circuitry 338 maintains the MOSFET 306 in a non-conductive state.

During normal shunting operations of the circuit 300, the TIC 302 senses the time-varying signal while the capacitor 324 discharges from the greater threshold voltage back to the lesser threshold voltage. Such discharging is done by way of the resistor 322 and a discharge signal provided at pin 7. During this shunting phase, the TIC 302 provides a “low” state control signal at pin 3 and the inverter circuitry 338 maintains the MOSFET 306 in a conductive state.

### Illustrative Circuit Constituents Table

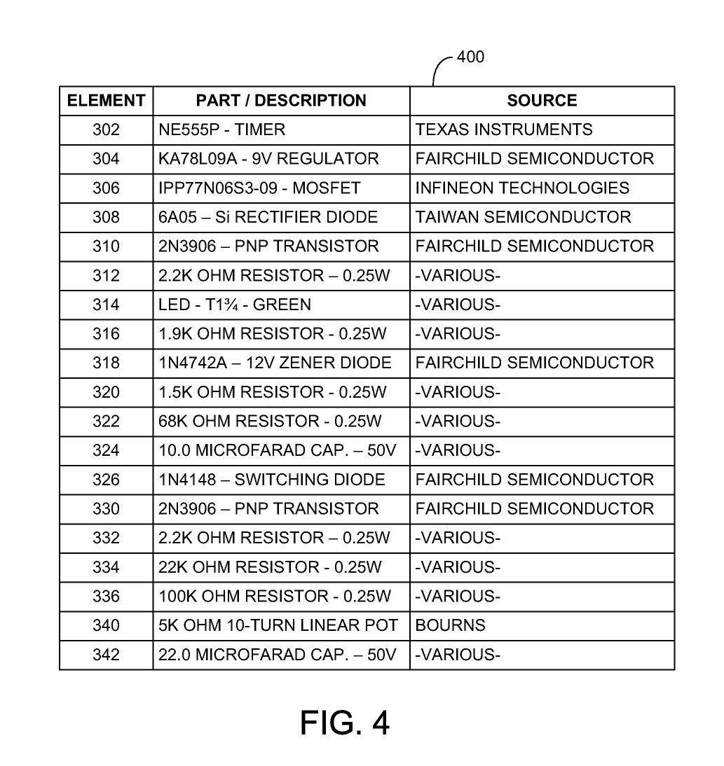

Reference is now made to FIG. 4, which depicts a table 400. The table 400 includes specific models, electrical characteristics and commercial sources for elements of one illustrative embodiment of the circuit 300. Other embodiments of charge controller circuitry having other respectively varying constituencies can also be used.

### Illustrative Performance Table

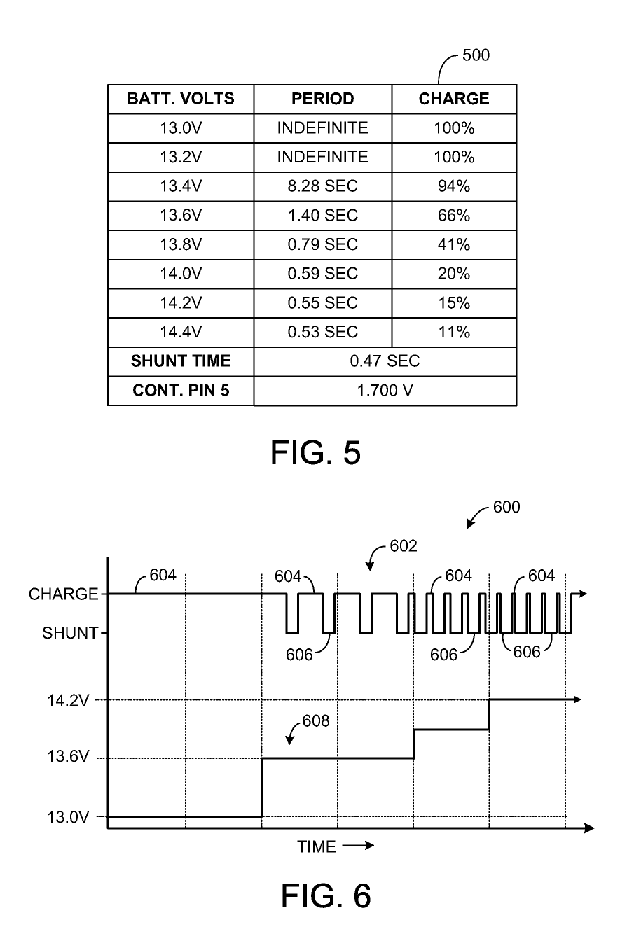

Attention is turned now to FIG. 5, which depicts a table 500. The table 500 includes data obtained by test bench measurements of a physical, working embodiment of the electronic circuit 300. Specifically, the table 500 includes an ascending list of data records, each record including a storage battery voltage, a corresponding time period for a control signal provided at pin 3 of the TIC 302, and a corresponding percentage-of-charge for that time period. Other data corresponding to other respectively varying embodiments can also be used in accordance with the present teachings.

For example, a battery voltage of 13.2 volts corresponds to an indefinite time period for the control signal, in which the storage battery is being charged for 100% of the time. In a contrast, a battery voltage of 13.8 volts corresponds to control signal periods of about 0.79 seconds each, in which the storage battery is being charged for about 41% of each period. The table 500 also documents a greater threshold voltage of 1.700 volts as measured at pin 5 of the TIC 302. Furthermore, a shunting time of about 0.47 seconds applies to each control signal period having a shunting phase and a charging phase.

### Illustrative Signal Timing Diagram

Attention is now turned to FIG. 6, which depicts a signal timing diagram 600 according to one example of the present teachings. The signal timing diagram (diagram) 600 is illustrative and non-limiting in nature. The present teachings contemplate other embodiments or operations corresponding to other signal timing diagrams.

The diagram 600 includes a control signal 602. The control signal 602 is also referred to as a digital signal or digital control signal for purposes of the present teachings. In one example, the control signal 602 is provided at pin 3 of the TIC 302 of the circuit 300. The control signal 602 is characterized by charging states 604 and shunting states 606.

The charging states 604 are time-varying (i.e., variable duration) in accordance with a storage battery voltage. In turn, the shunting states 606 are about time-equal (i.e., equal duration). Duty cycle, as used herein, is defined by the percentage of time that the control signal 602 is in the charging state 604. The control signal 602 is a variable-frequency signal due to the time-varying charging states 604. The control signal 602 is also essentially asynchronous, as no clock or other synchronization signal is used.

The diagram 600 further includes a storage battery voltage signal (battery signal) 608. The battery signal 608 is depicted as a step-wise rise in voltage over time for the sake of simplicity and clarity. However, the present teachings contemplate any number of operating scenarios wherein the voltage of a storage battery varies in accordance with any number of signal patterns. As depicted, the battery signal 608 step changes over time from about 13.0 volts DC to about 14.2 volts DC.

The duty cycle of the control signal 602 corresponds to the present value of the battery signal 608. For example, the duty cycle of the control signal 602 is 100% while the battery signal 608 is about 13.0 volts. Additionally, the duty cycle of the control signal 602 is about 66% while the battery signal 608 is about 13.6 volts. Furthermore, the duty cycle of the control signal 602 is about 15% while the battery signal 608 is about 14.2 volts. Other duty cycle/battery signal correspondences can also be used.

In general and without limitation, the present teachings contemplate solar-powered storage battery charge controllers and their operations. A charge controller is configured to receive electrical energy from a solar (i.e., photovoltaic) panel (or array of panels) and to regulate a transfer of such electrical energy to a storage battery (or batteries). The charge controller includes an integrated circuit having timer circuitry.

The timer circuitry monitors a time-varying signal across a capacitor of a timing network, which is compared to a lesser threshold voltage and a greater threshold voltage. The greater threshold voltage is directly adjustable by way of a potentiometer. The lesser threshold voltage is about half of the greater threshold voltage by virtue of voltage divider circuitry internal to the integrated circuit. The timing network charges the capacitor by way of a storage battery voltage. The capacitor is discharged by way of discharge signal provided by the timer circuitry.

The timer circuitry provides a digital control signal in accordance with the comparisons described above. The control signal is characterized by respective charging states and shunting states. The duty cycle of the control signal corresponds to the storage battery voltage. In particular, the charging states are time-varying, decreasing in time length in response to increasing storage battery voltage. The shunting states are about time-equal and are not a function of the storage battery voltage. The control signal is therefore variable frequency in nature, and is asynchronous because no clock or other analogous signal is used.

The control signal is used (directly or indirectly) to bias a shunting element or switch, such as a power MOSFET transistor. The shunting element is biased electrically conductive or “on” so as to shunt electrical current back to the solar panel during each shunting state. Conversely, the shunting element is biased electrically non-conductive or “off” so as to allow electrical current to charge the storage battery during each charging state.

Electrical current flows from the solar panel through a diode to the storage battery during charging states. The diode also electrically isolates the storage battery and a portion of the charge controller from the solar panel during shunting states. The diode further prevents (or nearly so) electrical current from flowing “backwards” from the storage battery to the solar panel. Indicator circuitry is configured to illuminate an LED in response to electrical current through the diode during charging states.

Charge controllers according to the present teachings do not require nor include any element that operates in accordance with a machine-readable program code. Thus, no microprocessor, microcontroller or the like, nor corresponding program code (i.e., software or firmware), is contemplated. Additionally, charge controllers according to the present teachings operate without need for Internet access or Internet-based resources, user password entry, or the like.

Thus, the present teachings contemplate charge controllers that operate unencumbered by Internet service provider fees, cloud computing contracts, the expense and waste stream of ongoing consumables replacement, or other dependencies upon parasitic third-parties. Such charge controllers can be constructed using electronic components, integrated circuit sockets, single-layer circuit board topologies and other features that lend themselves to maintenance and repair by appropriately skilled hobbyists, do-it-yourselfers and the like.

The foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

Furthermore, specific circuits having specific component models and/or values have been described. It is to be understood that other circuit component values and/or make/model designations can also be used in accordance with the present teachings. Thus, the present teachings contemplate the use of other suitable components having respectively varying electrical characteristics.

What is claimed is:

1. An electronic circuit, comprising:
a zener diode and a first resistor and a second resistor and a capacitor connected in series circuit arrangement and defining at least a portion of a timing network, the timing network electrically connected between an output node and a ground node, the timing network configured to provide a time-varying signal;
timer circuitry configured to provide a digital signal by way of comparing the time-varying signal with a lesser threshold voltage and a greater threshold voltage, the digital signal characterized by about time-equal shunting states and time-variable charging states; and
a switching element configured to shunt an input node to the ground node in accordance with the digital signal.

2. The electronic circuit according to claim 1, the timer circuitry configured to discharge the capacitor from the greater threshold voltage to the lesser threshold voltage by way of the second resistor.

3. The electronic circuit according to claim 1, the timing network including a switching diode coupled in parallel circuit arrangement with the second resistor, the capacitor configured to charge from the lesser threshold voltage to the greater threshold voltage by way of the zener diode and the first resistor and the switching diode and the second resistor.

4. The electronic circuit according to claim 1 further comprising a diode connected between the input node and the output node.

5. The electronic circuit according to claim 4 further comprising indicator circuitry configured to provide a visual signal in response to current flow through the diode.

6. The electronic circuit according to claim 5, the indicator circuitry including a light-emitting diode.

7. The electronic circuit according to claim 1 further comprising a voltage regulator configured to provide a constant voltage by way of a battery voltage present at the output node, the constant voltage being coupled to the timer circuitry.

8. The electronic circuit according to claim 1, the switching element including a power metal-oxide semiconductor field-effect transistor (MOSFET).

9. The electronic circuit according to claim 1 further comprising inverter circuitry configured to electrically couple the switching element to the digital signal.

10. The electronic circuit according to claim 1, the timer circuitry defined by an integrated circuit.

11. The electronic circuit according to claim 1 further comprising a potentiometer coupled to the timer circuitry, at least the greater threshold voltage being adjustable by way of the potentiometer.

12. A solar power system, comprising:
a photovoltaic panel configured to derive electrical energy by direct conversion of incident solar energy;
a storage battery configured to store electrical energy; and
a charge controller configured to regulate a transfer of electrical energy from the photovoltaic panel to the storage battery, the charge controller configured to shunt electrical current back to the photovoltaic panel in accordance with a control signal, the control signal characterized by about time-equal shunting states and time-variable charging states.

13. The solar power system according to claim 12, the charge controller further including an indicator circuit to provide a visual indication in response to an electrical current flow from the photovoltaic panel to the storage battery.

14. The solar power system according to claim 12, the charge controller configured such that the time-variable charging states correspond to a voltage of the storage battery.

15. The solar power system according to claim 12, the charge controller not including any entity that operates in accordance with a machine-readable program code.
